(19) United States
(12) Patent Application Publication
(10) Pub. No.: US 2022/0284508 A1
(43) Pub. Date: Sep. 8, 2022

(54) A DISTRIBUTED COMPUTING ARCHITECTURE WITH SETTLEMENT MECHANISM TO ENABLE TRACEABILITY OF CREDIT TOKENIZATION, DISBURSEMENT AND REPAYMENT

(71) Applicant: SEATIG INC., New York, NY (US)

(72) Inventor: Avery Starr, Briarcliff Manor, NY (US)

(21) Appl. No.: 17/633,450

(22) PCT Filed: Aug. 7, 2020
(86) PCT No.: PCT/US2020/045483

§ 371 Date: Feb. 7, 2022

(30) Foreign Application Priority Data
Aug. 7, 2019 (US) 62883687

(51) Int. Cl. G06Q 40/04; G06Q 20/36

(52) U.S. Cl. CPC G06Q 40/04; G06Q 20/3678

(57) ABSTRACT

A distributed computer architecture with a settlement mechanism to enable traceability of credit tokenization, disbursement, and repayment. A distributed ledger platform tokenizes credit for a project by recording one or more cryptographic tokens representing the credit on a ledger. A centralized business logic platform receives and stores account information for plural participants and associates a subset of the participants as designated participants for a project. A user interface allows the designated participants to transfer the cryptographic tokens on the distributed ledger platform to other designated participants in a peer-to-peer multi-level manner. For example, a grant can be distributed amongst many parties by distribution of the tokens. After receipt of the tokens, the various participants can request sign-off and redemption of the tokens to receive value, such as fiat currency for the tokens. Each transaction can be tracked on the ledger to provide traceability of grant funds.

### RELATED APPLICATION DATA

This application claims benefit to U.S. Provisional Application Ser. No. 62/883,687 filed on Aug. 7, 2019, the disclosure of which is incorporated herein in its entirety.

### BACKGROUND

Computer networks have become ubiquitous, to the extent that most communication between participants in various activities occurs over a computer network. Email, purchasing goods and services, supply chain tracking, and content distribution are just a few of the activities that are conducted between various parties over a computer network, such as the internet. It has been known to control a party's activities in a networked environment using complex permission mechanisms, such as digital rights management (DRM) and authorization mechanisms. However, many activities conducted over computer networks have many tree-like levels of dynamic relationships between the parties and thus it can be cumbersome to apply known permission mechanisms to limit behavior of the parties to desired activities. Further, in many instances, adequate computing infrastructure is not available and thus DRM and other permission mechanism are not pragmatic.

There are many applications in which assets flow from a first party to other sub-parties in different levels at the selection of the first party. For example, capital, such as for a grant, may be provided to a government entity for a project. The capital can then flow through multiple levels of parties and sub-parties that are selected by parties in the immediately preceding level. It is, of course, important to make sure the end recipients of the capital both meet the proper qualifications/responsibilities of the project and receive the allocated amount they are supposed to receive. Since the recipients in a level are often selected by recipients in the immediately preceding level, the original granting party may have very little control over who receives the capital. The current business practice in grant distribution often penalizes the end beneficiaries with significant amount of money lost in the middle layers of the delivery channel. Sometimes, the money simply does not reach the intended end beneficiaries at all, especially in jurisdictions that do not have a strong computing infrastructure. Other examples of dynamic multi-leveled asset distribution include procurement budgeting and supply chain accounts receivables.

It is critical to ensure the integrity of Who, What, How Much, and When in the process of budgeting, procurement, and project execution, especially in regions where corruption is widespread. The current business practice makes it very difficult to know:
the identity of the parties receiving funds that deeply embedded in the levels of the project,
the legitimacy of parties in the project,
the capabilities of parties in the project,
the scope of the project,
what party is responsible for each task of the project,
project budgets, and
project completion time.

It has been known to use complex project management tools to track projects and control party behaviors. However, such tools are often not pragmatic in applications which have dynamic multi-level relationships between parties. First, current accounting systems or Financial Management Information System (FMIS) or Public Financial Management (PFM) systems render financial information management from a single entity point of view; they do not integrate the entire network of participating entities into the system. Therefore, each entity has its own records and there is no single source of truth of all transactions for all participants. This disconnection leaves space for inconsistency and fabrication and therefore enables corruption and makes auditing and supervision a difficult task. Traditional technologies also fail to provide a systematic and holistic check on inconsistency and fraudulent behavior of the entire business network.

Second, because various participating entities may use different FMIS, it is impossible to conduct automated audits among technologically heterogeneous systems or information silos. Usually auditors rely on information filed by the participant entities after the activities happened. Most often, those post-activity filings are even paper based or only human readable files such as a PDF file. The void of automation in auditing and analysis infrastructure emboldens corruption.

Recently it has been proposed that Distributed Ledger Technologies (DLT), such as blockchain, could be applied to various applications to increase transparency. DLT has the ability to obtain a shared, immutable and auditable record of transactions and data. Transactions are conducted through cryptographic “wallets” corresponding to entities. Further many projects have demonstrated the utility of “tokenizing” (i.e. creating a unique digital ID for) assets. However, current data models and architectures do not provide a common model for the tracking of dynamic multi-leveled relationships between parties.

### SUMMARY

The presently disclosed technology overcomes the above-identified disadvantages of the prior art, by leveraging distributed ledger technology to track the flow of tokenized credit among multiple parties in a dynamic multi-level environment in a manner that provides transparency and allows crowd-sourcing of verification of the parties and corresponding responsibilities. A centralized system can cooperate with the distributed ledger to manage access on an account basis and to provide visibility into data on the distributed ledger. This two layered architecture of DLT and centralized layers paired with asynchronous messaging system allow sufficient communication bandwidth for a very large network with tens of millions of nodes. The tokenization of credit permits the platform to track credit as it flows between parties in a complex manner. The traceability allows projects to be managed in situations where there are dynamic multi-level agreements between parties. The distributed architecture provides traceability across organizational and technological boundaries of the participating parties. The traceable evidence are then presented in various visual formats and access-controlled segmentation to enhance comprehension, audit, and investigation. The use of tokenized credit, and crowd sourced approval mechanisms, ensures that all parties have lived up to their obligations prior to receiving payment. The two layered architecture paired with asynchronous messaging system allow sufficient communication bandwidth for very large network with tens of millions of nodes.

One implementation is a distributed computer architecture comprising; a distributed ledger platform defined by plural participant nodes, each node executing node software and having at least one cryptographic wallet associated therewith, each cryptographic wallet defining an address with which cryptographic tokens can be associated on a shared ledger of the distributed ledger platform, wherein the distributed ledger platform includes a consensus mechanism for verifying transactions of tokens, the distributed ledger platform executing smart contracts for: tokenizing an amount of credit related to a project by recording one or more cryptographic tokens representing the credit on the ledger, governing transaction process flows between nodes, and storing multi-level relationships between participants associated with the nodes; and a centralized business logic platform having at least one computer processor executing instructions to: receive and store account information for plural participants, associate a subset of the participants as designated participants for a project, provide a user interface to allow the designated participants to transfer portions of the one more cryptographic tokens on the distributed ledger platform to other designated participants in a peer to peer manner and, in response to a redemption request from one or more of the participants, and in accordance with the multi-level relationships between participants, allow sign-off on the redemption request and redemption of the one or more cryptographic tokens for FIAT currency in accordance with the transaction process flows; and a messaging infrastructure configured to provide message exchange between the distributed ledger platform and the centralized business logic platform.

### BRIEF DESCRIPTION OF THE DRAWING

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown.

FIG. 1 is a schematic illustration of a computing architecture in accordance with disclosed implementations.

FIG. 2 is an example of a flow diagram of a work project process in accordance with disclosed implementations.

FIG. 3 is a schematic illustration of various process phases of an architecture in accordance with disclosed implementations.

FIG. 4 is an example of a user interface architecture in accordance with disclosed implementations

FIG. 5 is an example of a user interface architecture in accordance with disclosed implementations

FIG. 6 is an example of a user interface architecture in accordance with disclosed implementations. .

### DETAILED DESCRIPTION

Certain terminology is used in the following description for convenience only and is not limiting. Unless specifically set forth herein, the terms “a,” “an” and “the” are not limited to one element but instead should be read as meaning “at least one.” The terminology includes the words noted above, derivatives thereof and words of similar import.

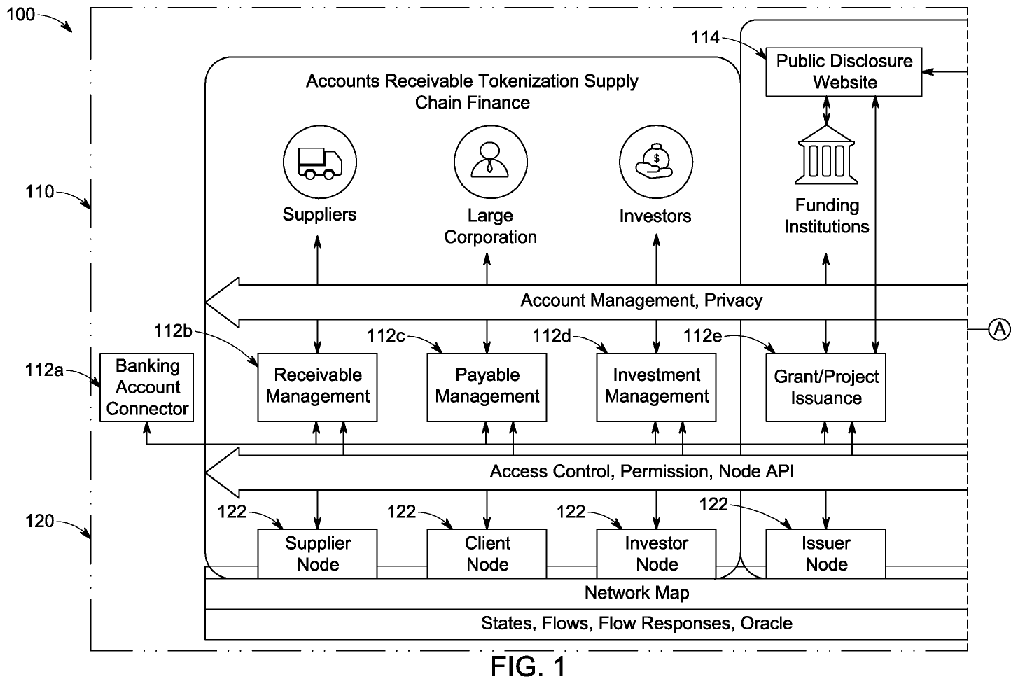

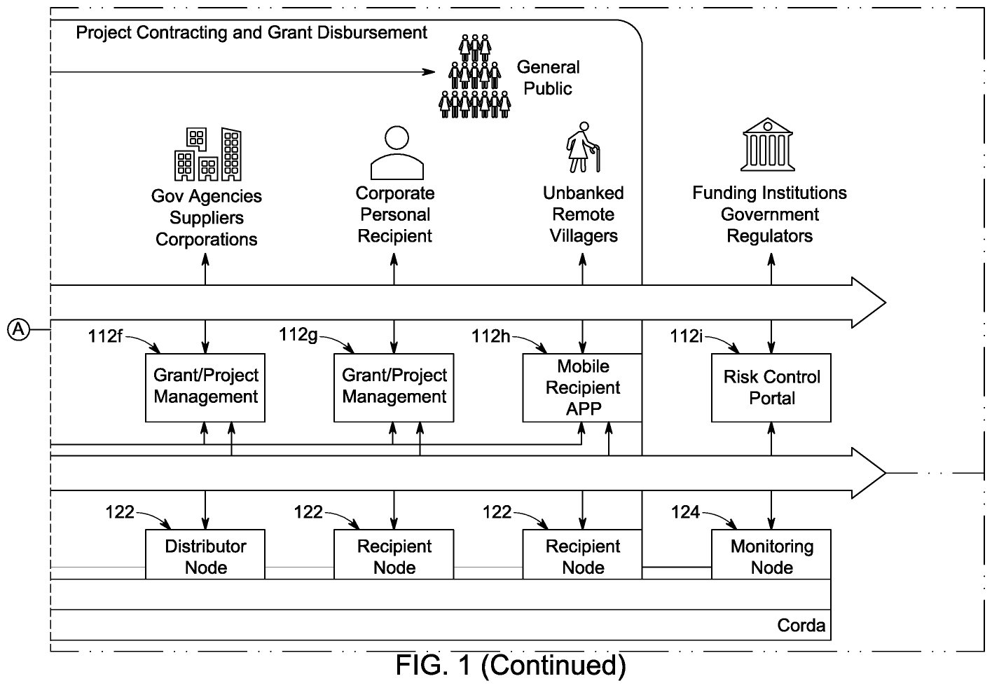

FIG. 1 illustrates a computing architecture in accordance with disclosed implementations. In FIG. 1, the elements are labeled as participants with various roles. However, it should be understood that each participant has one or more associated computing platforms including computer hardware processor(s) and memories storing software which, when executed by the processor(s) cause the processor(s) to execute the described functional modules on behalf of the participant, as will be described in greater detail below.

Disclosed implementations utilize a novel two-layer computer architecture that permits business process management techniques to leverage the immutability and transparency of a distributed ledger, while decreasing the need for computing resources as compared to conventional systems and methods. Disclosed implementations include settlement mechanisms to enable traceability of credit disbursement and redemption to counter corruption and misuse of fund in fiscal institutions and to ensure accountability of all actors involved in the financial delivery channel. The implementations manage projects to provide transparency and real-time traceability of money flow among all project participating entities. The term “project”, as used herein, refers broadly to any type of cooperative activity between parties and includes grant distributions, work projects (where the parties have obligations to perform specific duties) and accounts receivable relationships between parties.

As shown in FIG. 1, architecture 100 includes business logic layer 110 and DLT layer 120. Business logic layer 110 can be programmed in a known manner to accommodate any business/legal arrangements, roles, actors, and disbursement scenarios. For example, business logic layer 110 can be programmed using an object-oriented programming language, such as Java. DLT Layer 120 can be a blockchain architecture using various protocols such as such as Corda, Ethereum, or Hyperledger. DLT layer 120 uses public-private key encryption and authentication to manage and control access to the DLT nodes corresponding to the participants of one or more projects. DLT layer 120 can be a peer-to-peer decentralized Blockchain network for token transactions and business logic layer 110 can be a centralized distributed account based system, developed in Java for example, and having role-based and account-based interface portals for each participant.

Predetermined business processes (referred to as “flows” herein), cryptographic wallets, and tokenized credits are owned by the nodes. A “wallet” is a universal functional module for each participant (node) on the network. Only the owner can of a flow can execute that flow to trade and to manipulate the node's wallet. All asset tokens are hosted on a ledger of DLT layer 120 and protected by the keys and encryption. Therefore, tokens, or partial tokens, are owned by the participant nodes 122 and no one else can manipulate the token(s), or portions thereof, owned by a node other than the node itself.

Each participant must register and establish an account on the business logic layer 110 and thus the architecture can implement centralized control techniques. Conventional username/password account access can be used by the business logic layer 110; each asset transfer can require an additional separate password or other identity indicator. Identity management and authentication can be accomplished by business logic layer 110 through multiple known methods. For example, phone, email, address, website, and a personal identification number can be required. Business logic layer 110 can connect to each participant's respective bank account and thus the banking account information can be used further verify the identity of the user. Multiple authentications can be applied to protect against fraud.

Business logic layer 110, ensures that each account can only access the projects that have been assigned to that participant by maintaining records for each grant in Grant/Project modules 112f and 112g. No account can see other unrelated data and information. The concept of tranches for information access can be adopted. Different tranches of the same subject are assigned different access rights in a known manner. For example, a document can have a header and content. Header parameters include name, parties, amount, and status. During signoff (described below), upper layers can see the header information but only the immediate participant is able to see the content of the document.

In addition, the DLT implementation is based on need-to-know model for the how to store and replicate the data on each node of the DLT layer 120. The transaction data is only stored on the node(s) that actually participate in the transaction. Monitoring node 124 can have access to all transactions on the network by design. But the access is controlled such that only a party, such as a regulator, that should have such access to such data can access the monitoring node 124.

To establish a participant node in DLT layer 120, DLT node software can be installed on a user's computing device trough a download link or in another known manner. Each participant needs to establish a node in order to participate in transactional activities. Each participant node 122 of DLT layer 120 corresponds to a user entity and typically performs only one transaction at a time with another node therefore many nodes can perform transactions at the same time in a peer-to-peer manner without overwhelming the network. Further, asynchronous transactions are implemented among nodes and thus bottlenecks are avoided no matter how many nodes (i.e., participants/users) participate on the network or how many transactions are be processed at the same time.

Again, each node performs one transaction at a time; all different pairs can transact at the same time. Such an asynchronous transaction mechanism has two effects:
transactions between any pair of nodes does not affect other nodes and hence does not affect the network bandwidth; and
the DLT layer sends a message to the business logic layer after each successful transaction and thus even a large amount of ledger level transactions will not overwhelm the business logic layer processing.

As a result, the system, while having the advantages of centralized account management, can achieve higher transact bandwidth than conventional systems thus providing traceability of complex credit arrangements between parties in dynamic multi-level arrangements.

As noted above, DLT layer 120 of FIG. 1 can be based on and DLT protocol, such as the R3 Corda open source blockchain/distributed ledger platform, and can use RPC (Remote Procedure Call) to establish point-to-point links between nodes. All interactive nodes exist in the network map. Corda is state based. By initiating a flow to change/create the state when initiating the transaction, and to fulfill the contract obligation requirements, all states can be verified for parties of a transaction. A messaging protocol is used to pass the transaction information, and the counter party executes the flow response process to respond to the transaction. Then the transaction information agreed by both parties is stored in the node's persistent vault. The Corda vault contains data extracted from the ledger that is considered relevant to the node's owner, stored in a relational model that can be easily queried and worked with. The vault keeps track of both unconsumed and consumed states. Unconsumed (or unspent) states represent fungible states available for spending (including spend-to-self transactions) and linear states available for evolution (e.g. in response to a lifecycle event of a flow) or transfer to another party. Consumed (or spent) states represent ledger immutable state for the purpose of transaction reporting, audit and archival, including the ability to perform joins with app-private data (like customer notes). However, the term “vault” as used herein refers to any node-specific persistent storage. The vault can be customized, including the specific form of persistent objects. The implementations can use PostgresSQI, or any other appropriate database as a node persistence database.

The network map in Corda is a collection of signed NodeInfo objects. Implementations can use the Corda NetworkMap service or another service following the Corda Implementatoin Guide or other specifications. NodeInfo objects include information about a network node that acts on behalf of some party. NodeInfos can be found via the network map cache, accessible from a net.corda.core.node.services.NetworkMapCache. They are also available via RPC using the net.corda.core.messaging. CordaRPCOps.networkMapSnapshot method. Each NodeInfo will be encrypted and signed by the node it represents, so it cannot be tampered with. It forms a series of interactive nodes in a compatibility zone. A node can obtain these objects from the following two sources:
The network map server transmits through the HTTP protocol
In the additional-node-information directory under the node path

The network map server can also distribute a network parameter file that defines many configuration parameter values, and all nodes need to agree to these configuration parameters to be able to synchronize data in the network. The network map server will also distribute a file containing network parameters. This network parameter file defines many configuration parameter values, and all nodes need to agree to these configuration parameters to be able to synchronize data in the network.

A state represents an object that cannot be modified and which will be known by one or more nodes in the network at a certain point in time. States can contain any data, which allows it to represent any type of fact (such as stocks, loans, KYC data, identity data, etc.). Flows automate the process of updating states (in state based DLT such as Corda implementations) or transaction results (in other DLT implementations). Communication between the nodes occurs in the context of these flows in a peer-to-peer manner.

A valid transaction must be accepted by the corresponding smart contract executed by DLT layer 120, in all its input and output states. Such smart contracts can be written in a JVM programming language (e.g. java or kotlin). Contract execution must have a deterministic result, and its acceptance of a transaction is based solely on the content of the transaction. Corda provides a series of flexible query mechanisms to access Vault:
Vault Query API
Use JDBC session
Custom JPA/JPQL query
Custom third-party data access framework, such as Spring Data
Schema

DLT implementations, such as Corda, provides developers with a way to expose all or part of the contract state to an Object Relational Mapping (ORM) tool to persist it into an RDBMS. The purpose of this is to establish an effective index of the contract state saved in the vault, so that these states can be queried and the Corda data can be correlated with the local data of the organization that owns the node to help vault development. ORM mapping is specified by using Java Persistence API (JPA) as annotations, and each time a state is recorded in the local vault as part of the transaction, it will be automatically converted by the node into a record in the database table.

Business logic layer 110 and DLT layer 120 can use ActiveMQ™, an open source, multi-protocol, Java-based messaging protocol as a messaging platform. Business logic layer 110 uses contract transactions and DLT layer 120 processes the successful sending of ActiveMQ messages. This type of monitoring reads the message content, modifies the transaction status, synchronizes the remaining token amount of the contract between the two parties, and processes system indicators and other services. The DLT transaction, such as a Corda state, successfully triggers a confirmation ActiveMQ message to business logic layer 110 so that system indicators and other services can be processed in accordance with the ledger transaction. DLT layer 120 and business logic layer 120 can asynchronously process request and response messages to coordinate transactions and other activity.

In operation of architecture 100, after a “grant”, i.e. an initial extension of credit, is approved, instead of directly sending money to a party, for example the corresponding country finance ministry, the granting participant first tokenizes this grant on DLT layer 110 and disburses the tokens to a primary participant which in turn disburses the tokens to one or more next level participants. The process of disbursement can ripple through levels of participants and eventually the tokens reach end beneficiaries. As will become apparent below, the tokens can be redeemed for FIAT currency only when certain conditions are satisfied. Therefore, the tokens represent credit, not direct assets. In this manner, credit relationships can be managed and tracked for traceability. For example, responsibilities of a party can be confirmed, and it can be checked whether the responsibilities were satisfied before disbursing payments.

In the example of a “work project”, i.e. when the tokenized credit is used to compensate participants for goods or services, the grant issuer first tokenizes the grant and uses the tokens to pay a prime contractor who in turn uses to pay its sub-contractors or the end beneficiaries. The supply chain of contractors gradually forms as each level of sub-contractors win the bid and contracts are signed. A sub-contractor is added into the network by receiving the tokens from its superior contractor. There can be multiple levels of sub-contractors, and legal relationship contracts can be negotiated between any pair of contractor and sub-contractor. Tokens are then disbursed from the contractor to the sub-contractor for that contract. Terms and conditions of each negotiated contract can be recorded on the ledger of DLT layer 120 in the manner described below.

As noted above, once all transactions have been accomplished, funds are disbursed to the participants by redemption of tokens. The disbursement scenarios can be modeled as a full connected directed graph. Documents can be attached to each disbursement to provide the same level of traceability of documents (invoices, evidence, etc.) as the traceability of the transaction itself. DLT layer 120 provides tracing and tracking of transactions and of disbursements once funds are approved and move from the borrower through multiple players and ultimately to the end beneficiary. Blockchain layer 120 is designed at the infrastructure or protocol level, not as a software system, to allow integration with various systems of participants. Therefore, government agencies, for example, or other parties providing financing can choose their disbursement software and just “write” the disbursement instruction onto the common ledger of DLT layer 120. The “write” operation can be achieved by developing accounting system connectors to the ledger or the protocol can be exposed so the accounting system software vendors can develop the push instructions. With that approach, we can achieve traceability among heterogeneous systems. It is also possible for the DLT layer 120 to interoperate with other DLT systems, such as various blockchains, if a common definition is created for the token and messaging format. Activities, such as disbursement activities, are recorded in substantially real time and thus there is no need for post activity data capture and reporting.

Architecture 100 can capture the following data:
1) at registration, user identification data and corporate profile data;
2) a party's banking account data (such as through third party software, such as Plaid);
3) using New Project, New Grant, and New Contract modules described below, grant, project, and contract data;
4) disbursement action related data is automatically recorded on the ledger along with all relevant documentation.
5) disbursement activity data from different accounting systems and disbursement.

Connectors to other accounting systems can be used to push payment instructions to the accounting system for direct cash transfers. All asset (digital asset, i.e., token) data and changes of asset ownership (i.e., transactions) can be stored on a decentralized and distributed ledger of DLT layer 120 and all account and business process related data can be stored on business logic layer 110. All of this data can be shared between the two layers.

As noted above, one example application of the disclosed implementations is in managing a project of grant disbursements. In such an example four types of licenses can be granted and enforced by business logic layer 110:
Grant Issuance license issued to,
   a grant Issuer node owned directly by funding institutions/agencies or by grant operating company working on behalf of the funding institutions/agencies);
Grant Management license issued to,
   a grant distribution node owned by layers of government agencies or NGOs to distribute the grant to their subordinate entities or end beneficiaries in their administrative scope;
   a grant recipient node owned by end grant receiving entities or end beneficiaries; or
   a grant recipient mobile node owned by recipients who are using the mobile App.
Grant Disbursement license issued to,
   a grant distribution node owned by layers of government agencies or NGOs to distribute the grant to their subordinate entities or end beneficiaries in their administrative scope;
Grant Redemption license,
   issued to a grant recipient node owned by end grant receiving entities or end beneficiaries.

Another example application of the disclosed embodiments is the above-noted work project which has the following two types of licenses:
Project Issuance license
   granted to a project Issuer node owned directly by funding institutions/agencies or by project operating company working on behalf of the funding institutions/agencies;
Project Management license,
   granted to a project contractor node owned by prime contractors and various level of sub-contractors of the project;
   granted to a project contractor node owned by Leaf-level subcontractors;
   granted to project funding recipient node owned by end beneficiaries.

Yet another example application of the disclosed implementations is an accounts receivable tokenization and supply chain finance management project which has the following three types of licenses:
Payable Management license,
   granted to a client/buyer node owned by large corporations
Receivable Management license;
   granted to a supplier node owned by the tiers of suppliers;
Investment license,
   granted to an investor node owned by investors in a supply chain finance market

Business logic layer 110 can include various functional modules. Banking account connector 112a of business layer 110 connects each account/node with a corresponding banking account so that automated banking account deposits can be accomplished receives approval for a request for redemption of a token. Banking account connector 112a can be a third party product, such as Plaid™. Receivable management module 112b implements a portal for suppliers to tokenize their accounts receivable (discussed below). Payable management module 112c is implements a portal used by enterprise participants to pay accounts payable using tokens. Investment management 112d implements a portal for investors to manage tokens they have invested in. Grant/Project management module implements a portal for intermediate government agencies or end beneficiaries to receive, disburse, and redeem tokens. Grant/Project issuance modules 112f, and 112g implements respective portals for an issuer to tokenize grants/projects. Mobile recipient app module 112h implements a grant management portal on a mobile platform that enable offline operations through a client mobile app. The functional modules have implementations on DLT layer 120 as well as business logic layer 110. On DLT layer 120, the functionality of each module is realized by the combination of States, Flows, and Flow Response.

Public disclosure website 114 can be hosted by the grant issuer in their public World Wide Web website open for the public to view and report any suspicions, thus crowdsourcing fraud detection. Public disclosure website 114 is connected to grant issuer's platform 112e but is not connected directly with DLT layer 120 in this implementation.

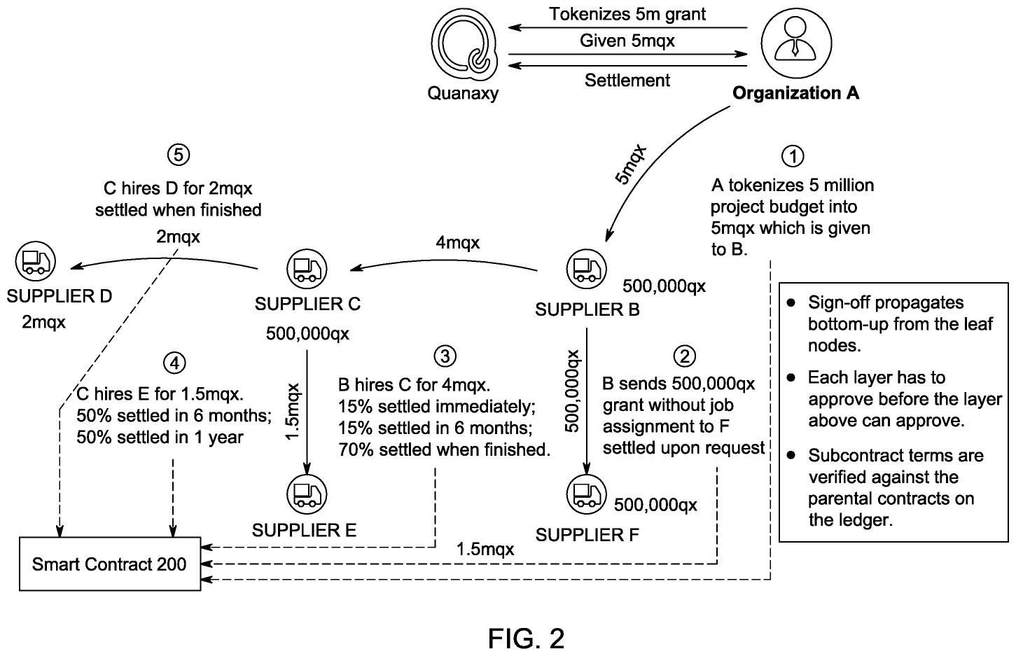

FIG. 2 illustrates a simple example the flow of tokenized funds between parties in the example of a work project. In this example, the participants can be various levels of suppliers in a supply chain. Similar flows occur in other project applications. As illustrated in FIG. 2, Organization A extends $5,000,000 of credit which is tokenized by DLT layer 120 as 5,000,000 million tokens. The tokens used in this example are referred to as “QX” tokens. At step 1, the 5,000,000 tokens are transferred to Supplier B which in turn distributes 500,000 tokens to Supplier F (step 2) and 4,000,000 tokens to Supplier C (step 3). Supplier C distributes 1,500,000 tokens to Supplier E, at step 4, and 2,000,000 tokens to Supplier D, at step 5. Each distribution of tokens corresponds to a business agreement between the parties including responsibilities of the parties, payment terms, penalties for non-compliance, and the like.

The parties contract, i.e. establish legal agreements, through a portal of business logic layer 110 of FIG. 1 and all contracts are recorded in correspondence to the work project as a Smart Contract 200 in the ledger of DLT layer 120 (as indicated by the dashed arrows in FIG. 2). This results in an immutable and traceable record of all relationships between the parties and terms of the agreements between the parties. Note that “smart contract” commonly refers to any executable code stored on a distributed ledger. However “Smart Contract” (with upper case), as used herein, refers to data structure(s) stored on the distributed ledger and which represent the multilayer relationships between the parties and the terms of contracts, i.e. legal agreements) between the parties. The following are examples of the data structure definitions that can be included in the Smart Contract

### Base State Definition:

```
/**
    * id
    */
  private final UUID id;
  /**
    * Business id (id associated with java)
    */
  private final String businessId;
  /**
    * java user id
    */
  private final String operatorId;
  /**
    * linearID
    */
  private final UniqueIdentifier linearId;
  /**
    * Monitoring node
    */
  private final Party quanaxy;
  /**
    * The transaction amount
    */
  private final BigDecimal tradingAmount;
  /**
    * Current node balance
    */
  private final Amount<Issued<Currency>> faceValue;
  /**
    * owner
    */
  private final Party owner;
  /**
    * Counterparty
    */
  private final Party tradingCounterparty;
  /**
    * Total business amount
    */
  private final BigDecimal totalTokenizationAmount;
  /**
    * Handling fee
    */
  private final BigDecimal trasanctionFees;
  /**
    * currency
    */
  private final Currency currency;
  /**
    * Payer node
    */
  private final Party feePayer;
  /**
    * Trading start time
    */
  private final Instant startTime;
  /**
    * Business balance after this transaction
    */
  private final BigDecimal faceValueNow;
  /**
    * Balance after this transaction
    */
private final BigDecimal faceValueByVault;
```

### Project State Definition:

```
/**
    * project name
    */
  private final String projectName;
  /**
    * Total project amount
    */
  private final BigDecimal projectAmount;
  /**
    * Project start time
    */
  private final Instant projectStartTime;
  /**
    * Project end time
    */
  private final Instant projectEndTime;
  /**
    * Contract minimum payment amount
    */
  private final BigDecimal minimumContractPayment;
  /**
    * Issuer
    */
  private final Party Issure;
  /**
    * Parent contract id
    */
  private final UniqueIdentifier parentContractId;
  /**
    * Contract name
    */
  private final String contractTitle;
  /**
    * Party A
    */
  private final Party partyA;
  /**
    * Party B
    */
  private final Party partyB;
  /**
    * Contract amount
    */
  private final BigDecimal contractAmount;
  /**
    * Payment rules
    */
  private final String contractPaymentRulesMap;
  /**
    * Deduction rules
    */
  private final String contractPenaltyRulesMap;
```

### Grant State Definition:

```
/**
    * monitor node
    */
  private final Party monitor;
  /**
    * grant name
    */
  private final String grantName;
```

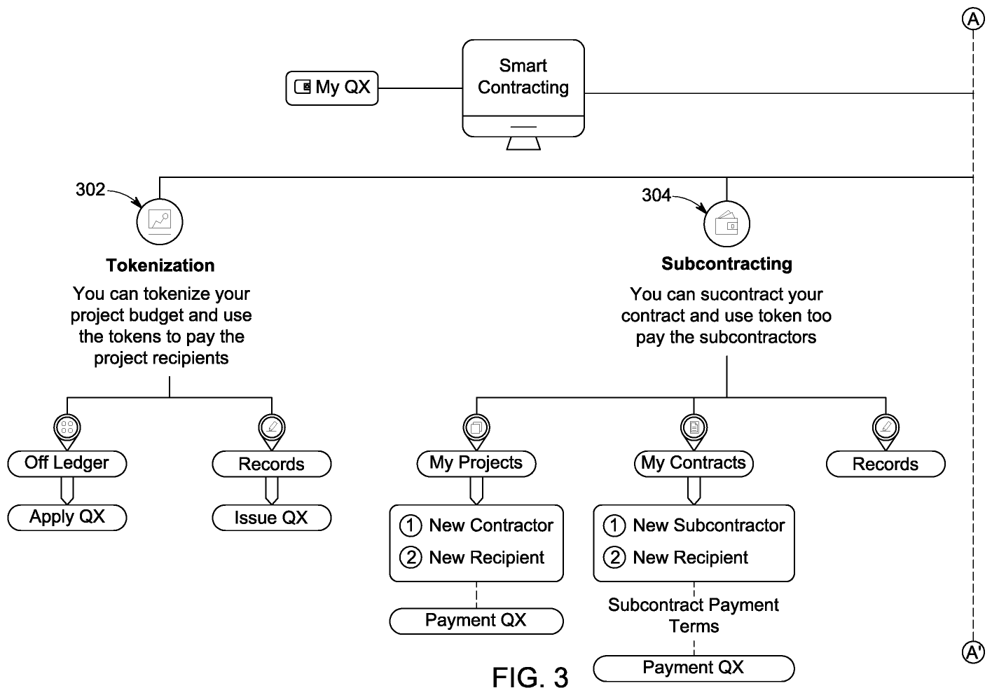

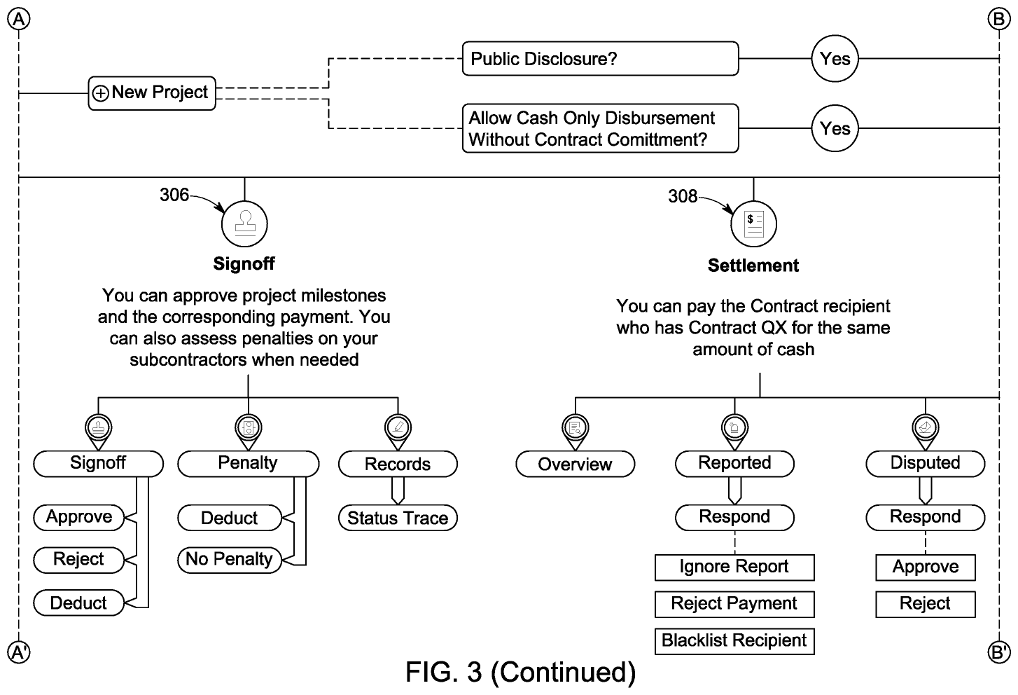

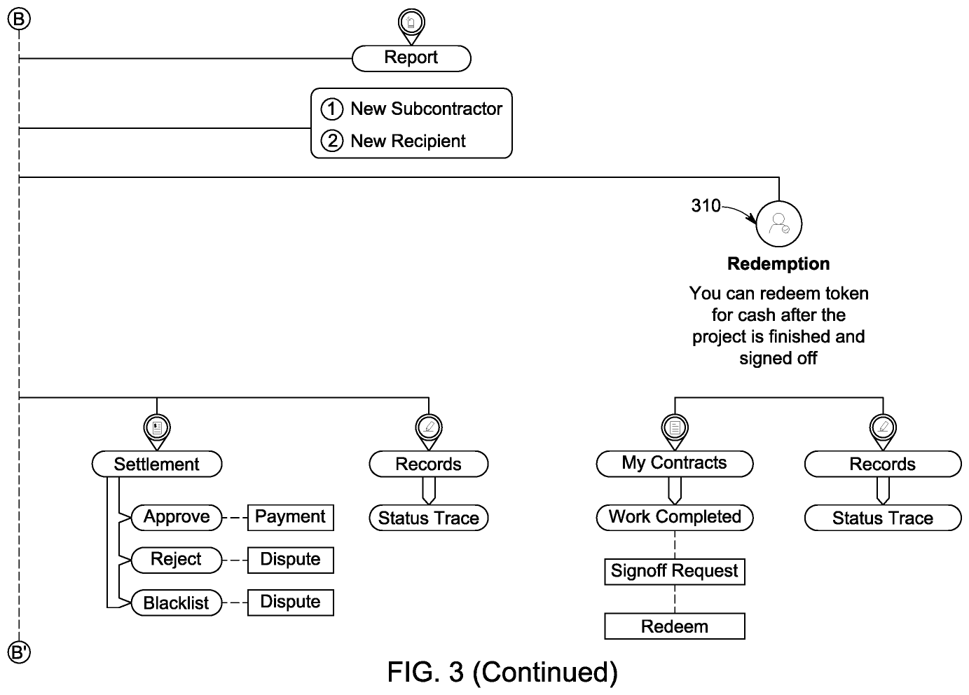

In the example of FIG. 2, after the flow is accomplished, which is processed and tracked in the manner described below with respect to FIG. 3, when settlement is requested by the participants, the following are the amounts of tokens that each party has which can be redeemed for FIAT currency:
Supplier B—500,000;
Supplier F—500,000;
Supplier C—500,000;
Supplier E—1,500,000;
Supplier D—2,000,000.

FIG. 3 illustrates the process phases of a disclosed implementation. Each phase can be implemented by the disclosed modules including computer hardware executing software instructions. Tokenization 302 is accomplished by DLT layer 120 which tokenizes the initial “grant”, i.e. the total credit value, for tracking. A grant is “off ledger” before being tokenized. Once the grant is tokenized, the equivalent amount of QX tokens are issued to the network. The grant issuer can then disburse these newly issued tokens to its recipients (e.g. through subcontracting), who can then redistribute tokens through multiple levels in the manner described with respect to the example of FIG. 2. Subcontracting 304 is accomplished by DLT layer 120 which includes the on-ledger Smart Contracts indicating the contracting relationships as described above. If the grant is used for a specific task, i.e. the project is a work project, the token disbursement process is the process when the entity subcontracts its contracts to its suppliers. The subdivision of the payment terms (including penalty terms) is coded into the Smart Contract. The Smart Contract can be parsed and validated in various manners:
Subdivision: the payment terms and penalty terms of subcontracts are validated against the parent contract at each step of subdivision.
Performance signoff: Smart Contracts are verified against the supplier project performance when the supplier requests redemption.
Cross examination: algorithms that can “regulate” the relationships of the contractor at the same layer. For example, if the project is to build a bridge, there will be different types of contractors, design engineers, raw material sellers, paving engineers, truckers, etc. For example, if the paving engineers are claiming their token before the design engineers request theirs, the claim won't be able to go through the system because the algorithm requires that paving must be done after design is finished. This algorithm can be implemented in the form of settlement sequence Levels.

A user interface can be provided to allow a specified user, with the appropriate license, to configure the payment and other terms of each subcontract that is coded into the Smart Contract. Projects and contracts are divided into phases. The user can choose different subcontractors to be assigned to different phases. Settlement 308 is the process for regulating the settlement order for subcontractors at each layer. The payment terms and penalty terms of the subcontracts are entered by the user and are validated against their parent contracts.

Smart Contract coding is not required if the grant is only for monetary assistance without any contractual obligation, i.e. a grant project as opposed to a work project. It is possible to mix the disbursements using Smart Contracts with disbursements not using a Smart Contract throughout the disbursement chain. There can be a single disbursement model or the model can be mixed at each layer of the disbursement chain.

If the monetary disbursement inherits from a parent contract which has phases, the redemption requirements for the monetary token will inherit payment data of the assigned phase as well.

When the suppliers finish their assigned projects according to the contract terms, they can make a request for signoff 306 and redemption 310, i.e., to exchange their QX token holdings (credit) for cash or other value. Attachment of an invoice can be required with a signoff and redemption request. Redemption requests are stored in a manner similar to the settlement records.

As each participant in a project is responsible for just a subdivided portion of the entire project, the redemption request will first be sent to the participant immediately above the requesting participant for a signoff process 306. Once approved, the request will be propagated to the next level participant for signoff. The process continues through each level until it reaches the initial grant issuer.

In addition to automated smart contract validation, the system provides traceability of information to allow parties to make an informed decision of whether or not to approve a redemption request. Various traceability graphs will be discussed below. Examples include:
Node to Origin traceability: the contract amount of each supplier can be clicked to show the Node to Origin traceability graph to reveal how does this supplier get its contract at each step until reaching the origin (issuer).
Penalty Drill Down traceability: if one supplier was accessed penalty from its client, this graph shows how this penalty was subdivided and attributed at each level below.
Chain of Approval traceability: it tracks layers of approvals and the associated contract information. The approval chain is propagated bottom-up starting from the client of the redemption requester.

Penalties for non-compliance with contract terms can be assessed during the sign-off phase, in accordance with the Smart Contract. If a participant is accessed a penalty from its contracting party, it can assign the attribution of the penalty to the responsible suppliers below them in the contract chain. The penalty assignment is a top-down drill process until one or more participants accept all of the assigned responsibility and perform no further drilldown. The signoff process is bottom-up but the penalty attribution is top-down. A smart contract of signoff module 306 can flag a warning in the chain-of-approval.

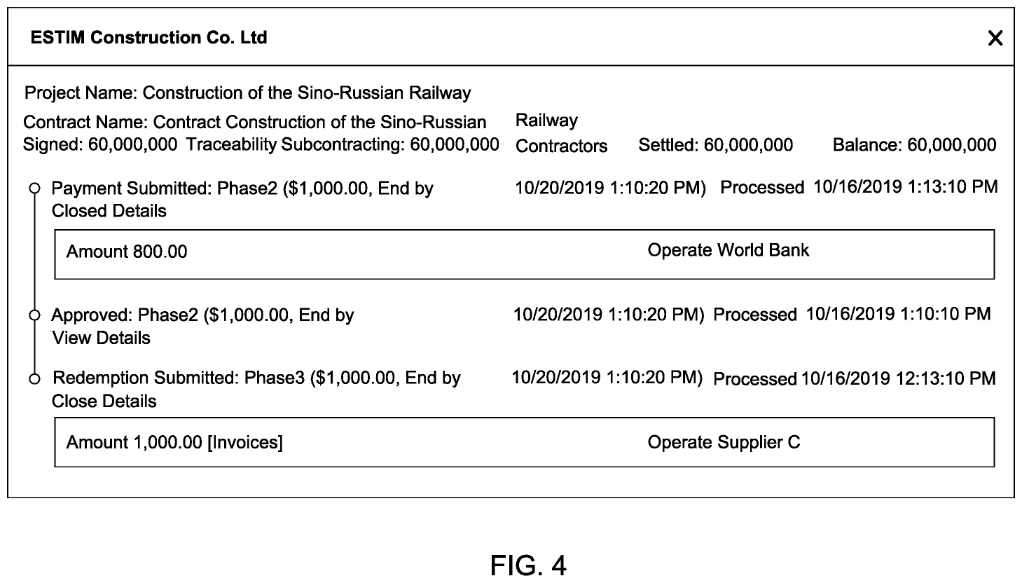

Once the signoff process is finished, the redemption request of the participants will appear at the settlement portal of the grant issuer. In the case of cash assistance, the redemption request will directly go to a settlement portal where the status of each redemption request including the amount settled, requested, public disclosure status, and other information can be displayed. Each recipient name can be clicked to pull up a Node-to-Origin traceability graph to show how this recipient received the funding. A redemption requests can be rejected or the requesting node (requester) can be blacklisted. Manual payment results can be entered after the payment was processed. All operations performed by both the grant issuer and the redemption requesters can be displayed in a records page. As shown in FIG. 4, a full trace of status changes with all relevant details of the operation of each requester can be seen by clicking a Status Trace button on user interface. Alternatively redemption requests can also be published if the project grant requires public disclosure. Public disclosure is designed to solve the last mile corruption problem, e.g., if a village head disburses the tokens to his own family members. Because the leaf nodes are the nodes that can finally redeem tokens to cash and upper layers might not process enough local knowledge of Who-is-Who, “public eyes” might have the best local information to report suspicion and wrong doings. The public disclosure component can be hosted on grant issuer's public website. The grant issuer can respond to the reports by rejecting the payment or blacklist the grant recipient. When a node is blacklisted, the associated participant is denied further access to the platform.

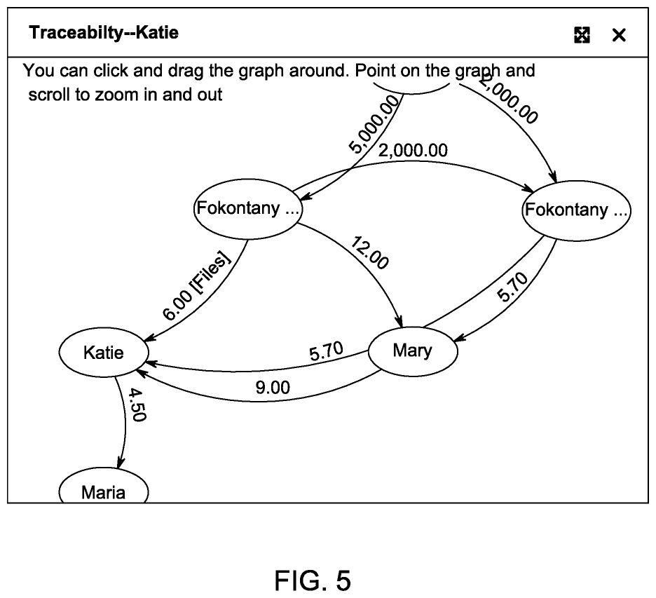

Node-to-Origin traceability reports, which show how funds flows from the origin to a specified node in a graphical manner, can be viewed by the grant issuer to check the legitimacy of each node's holding or past holding history. An example of such a report is shown in FIG. 5. It can be seen that all documentations associated with each transaction can be made available to be viewed and downloaded on the traceability graph. The example of FIG. 5 shows abnormal fund flow to Katie; normally Katie should only get her grant from her own “Fokontany”, i.e. local clan or cluster of families. However, FIG. 5 shows Katie receiving funds from multiple Fokontany. The graphical nature of the report makes it readily visible that Katie may be receiving improper funds. Without such a report, and graphical presentation, it may be difficult to detect that Katie received improper funds, especially when the payment paths are more complex than this simple example.

A Penalty Drill Down graph, showing a trace of penalty subdivision and attribution, can be displayed on the user interface. The root node is any target node the user wishes to start the investigation; the leaf nodes are the nodes who take the full assigned responsibility and do not further re-assign the penalty. Monitor nodes, such as monitoring node 124 of FIG. 1 can be included in the network. Typically, the grant provider or government supervisory entities can act as monitors. Monitors will get the real-time “Birds Eye View” of the network activities.

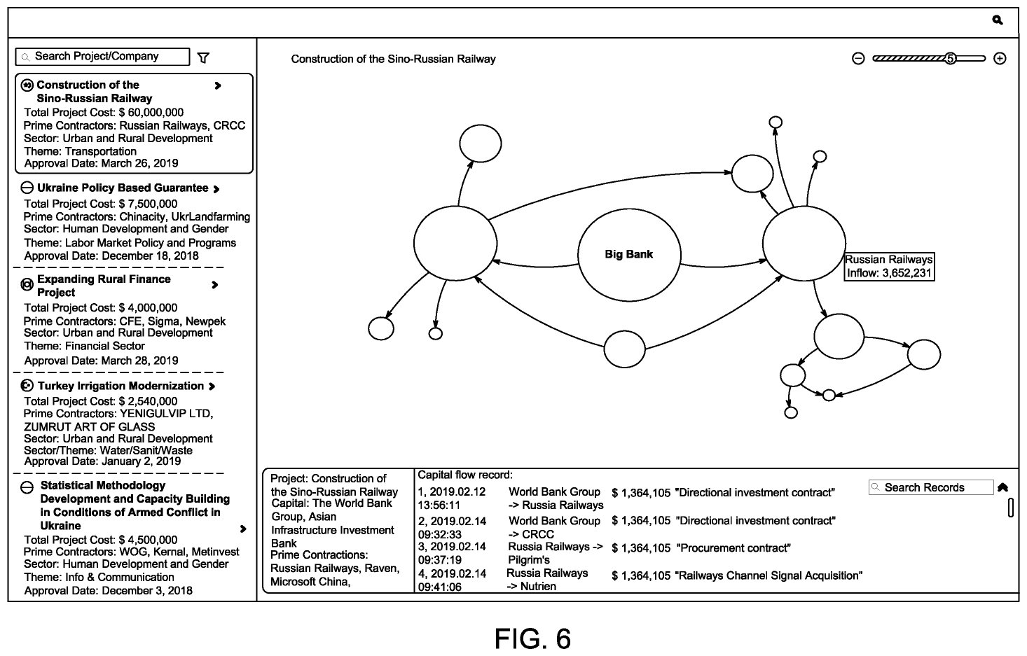

FIG. 6 illustrates an example monitoring portal Here it shows all projects of the Global Bank that are on the ledger of DLT layer 120. Selecting each project, we can see the entire network graph as well as detailed contracts of each transaction. Filters can be used to select a subset of relevant projects. When any entity is searched in the search bar, the relevant projects that contains this entity is filtered, and at the same time a sub-chain headed by this node is highlighted with the rest of the network fading into the background. The same effect of highlighting the subset of the network can be obtained by clicking on a node.

Banking account connector 112a, such as the software platform Plaid, can be used to instantly connect user's banking account to the system. The user only needs to sign in with their banking account username and password when it pops up. Alternatively, a user can be prompted to manually input their banking account information.

Grant/project issuance connector 112e connects the grant issuer's accounting cash payment system to automatically push for cash deposit for the recipients. Alternatively, the issuer can download recipient payment information and can process payment transactions offline. After the payment is processed, the operator can manually input the payment results.

Various DLT platforms and protocols can be used in connection with disclosed implementations. The disclosed implementations use Java code. However, various programming languages can be used to achieve the disclosed functions. The functions disclosed herein can be implemented by hardware computer processors. The processor may include one or more of a digital processor, an analog processor, a digital circuit designed to process information, an analog circuit designed to process information, a state machine, and/or other mechanisms for electronically processing information. In some implementations, processor(s) may include a plurality of processing units. These processing units may be physically located within the same device or may represent processing functionality of a plurality of devices operating in coordination. Processor(s) may be configured by software to execute modules As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules is for illustrative purposes, and is not intended to be limiting, as any of modules may provide more or less functionality than is described. For example, one or more of the disclosed modules may be eliminated, and some or all of its functionality may be provided by other ones of modules.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A distributed computer architecture comprising:
a distributed ledger platform defined by a plural of participant nodes, each node of the plurality of participating nodes executing node software and having at least one cryptographic wallet associated therewith, each cryptographic wallet of the at least one cryptographic wallet defining an address with which cryptographic tokens can be associated on a shared ledger of the distributed ledger platform, wherein the distributed ledger platform includes a consensus mechanism for verifying transactions of tokens, the distributed ledger platform executing instructions to:
tokenizing an amount of credit related to a project by recording one or more cryptographic tokens representing the credit on the ledger;
governing transaction process flows between nodes; and
storing multi-level relationships between participants associated with the nodes;
a centralized business logic platform having at least one computer processor executing instructions to:
receive and store account information for a plural of participants;
associate a subset of the plurality of participants as designated participants for a project;
provide a user interface to allow the designated participants to transfer portions of the one more cryptographic tokens on the distributed ledger platform to other designated participants in a peer to peer manner; and
in response to a redemption request from one or more of the designated participants, and in accordance with the multi-level relationships between the designated participants, allow sign-off on the redemption request and redemption of the one or more cryptographic tokens for FIAT currency in accordance with the transaction process flows; and
a messaging infrastructure configured to provide message exchange between the distributed ledger platform and the centralized business logic platform.

2. The architecture of claim 1, wherein the multi-level relationships between participants are stored in the distributed ledger platform with information indicating legal agreements between participants as a smart contract.

3. The architecture of claim 2, wherein the project is a work project and the smart contract includes project responsibilities assigned to the designated participant through the centralized business logic platform.

4. The architecture of claim 1, wherein the project is a monetary grant distribution project and transfers dispersed grant funds to the appropriate parties.

5. The architecture of claim 1, wherein the project is an accounts receivable based supply chain finance project and the tokenized assets represent accounts receivables of project participants.

6. The architecture of claim 1, wherein each wallet defines a universal functional module for a corresponding node on the network, and wherein process flows are associated with wallets whereby only the owner can of a process flow can execute a process flow.

7. The architecture of claim 1, wherein, in response to receiving a transaction request message from the business logic layer through the messaging infrastructure, the distributed layer technologies (DLT) layer modifies the transaction status of nodes, synchronizes token amounts between the nodes and triggers a confirmation message to the business logic layer that the transaction has been completed.

8. The architecture of claim 1, wherein the messaging infrastructure is an ActiveMQ infrastructure.

9. The architecture of claim 1, wherein the centralized business logic platform further executed instructions to provide a visualization of network-wide transaction evidence based on participant viewpoint and a selected tracing path, including a node-to-origin traceability graph, a penalty-drill-down, a bottom-up signoff chain, and complete network bird's eye view.

10. A method of a software application, the method comprising:
receiving a disbursement funding project for multi-layer funding distribution over a distributed ledger technology (DLT);
assigning a first layer of a multi-layer funding for the disbursement funding project as a first electronic token to a first entity;
enabling the first entity to assign a second layer of the multi-layer funding for the disbursement funding project as a second electronic token to a second entity;
releasing, based on a first authorization, the first electronic token via the DLT to the first entity; and
releasing, based on a second authorization, the second electronic token via the DLT to the second entity.

11. The method of claim 10, further comprising enabling the second entity to assign a third layer of the multi-layer funding for the disbursement funding project as a third electronic token to a third entity.

12. The method of claim 11, further comprising releasing, based on a third authorization, the third electronic token via the DLT to the third entity.

13. An apparatus comprising a processor and a memory, the memory storing code executable by the processor, the code configured to:
receive a disbursement funding project for multi-layer funding distribution over a distributed ledger technology (DLT);
assign a first layer of a multi-layer funding for the disbursement funding project as a first electronic token to a first entity;
enable the first entity to assign a second layer of the multi-layer funding for the disbursement funding project as a second electronic token to a second entity;
release, based on a first authorization, the first electronic token via the DLT to the first entity; and
release, based on a second authorization, the second electronic token via the DLT to the second entity.

14. The apparatus of claim 13, wherein the code is configured to enable the second entity to assign a third layer of the multi-layer funding for the disbursement funding project as a third electronic token to a third entity.

15. The apparatus of claim 14, wherein the code is configured to release, based on a third authorization, the third electronic token via the DLT to the third entity.
